(19) United States
(12) Patent Application Publication
(10) Pub. No.: US 2012/0064196 A1
(43) Pub. Date: Mar. 15, 2012

(54) MINCED FISH MEAT AND METHOD OF PRODUCTION OF MINCED FISH MEAT

(75) Inventors: Mitsutoshi KUBOTA, Hachioji-shi (JP); Manabu IIJIMA, Hachioji-shi (JP); Takayuki ISHIDA, Hachioji-shi (JP)

(73) Assignee: NIPPON SUISAN KAISHA, LTD., Tokyo (JP)

(21) Appl. No.: 13/231,605

(22) Filed: Sep. 13, 2011

(30) Foreign Application Priority Data
Sep. 13, 2010 (JP) 2010-203883

(51) Int. Cl. A23L 1/326; A22C 25/14

(52) U.S. Cl. 426/63; 426/643; 452/108

(57) ABSTRACT

The purpose of the present technology is to provide a frozen minced fish meat of high quality while effectively using a natural resource. During production of minced fish meat, after removal of the head, guts, and kidney tissue (kidneys), meat is harvested to produce a minced fish meat characterized in that gelation strength is not lowered. Specifically, this production method includes as essential steps a step of washing the fish body; a step of removing the head, guts, and kidney tissue; a washing step; and a meat harvesting step. Protease specific activity of the minced fish meat, as measured by the peptide quantitative analysis method using phenol test solution, is less than or equal to 0.001.

### FIELD OF THE INVENTION

The present technology relates to a method for production of minced fish meat (otoshimi) of improved quality. In particular, the present technology relates to a method for production of a minced fish meat that is suitable as a raw material for kneaded products (neri-seihin) having improved color and gel forming ability.

### BACKGROUND OF THE INVENTION

The production of surimi (water-leached minced meat) from fish meat has become a global industry that operates throughout the world. In recent years, however, surimi containing previously unused raw materials has been produced for reasons such as fishing restrictions and effective use of resources. Most fish species which are caught in large amount have a limited fishing season and are used as frozen surimi.

The basic principles of surimi production are as follows. After removing the head and guts from the raw fish, butterflied fillets, or deboned fillets are prepared. The fillets are then placed in a separator, from which fish meat is recovered in the form of minced meat. Water-soluble proteins, which inhibit the formation of gels, are removed from the proteins of this fish meat by soaking in water, skin, sinew, and bones are removed with a refiner, the fish meat is dehydrated, and the myofibrillar proteins, which are the main gel forming proteins, are condensed. This dehydrated meat is blended with a freeze-denaturation preventing agent such as a sugar, sugar alcohol and a polyphosphate and then frozen.

During the production of frozen surimi, most water soluble proteins are removed during the water leaching step and dehydrating step, even though such proteins should form the basis of nutrition and flavor. From the standpoints of the effective use of natural resources and reduction of the amount of waste, it goes without saying that it is preferable that minced fish produced without water leaching be usable. However, surimi can be readily stored frozen and has quite broad versatility, so the applications for frozen minced fish meat are limited. In the present technology, the term “minced fish meat” refers to fish meat taken from the fish without having been subjected to water leaching to remove water soluble proteins (as in the production of surimi). This minced fish meat is simply fish meat after removal of skin, sinews, bones, or the like.

Examples of fish that are often used as raw materials for surimi include Alaska pollack, Pacific whiting, Atka mackerel, sardine, horse mackerel, southern blue whiting, northern blue whiting, Atlantic cutlass fish, lizardfish, white croaker, golden threadfin bream, and splendid alfonsino.

Among such fish species, the surimi of the Atka mackerel family has poor gelation strength and is unsuitable as a raw material for kneaded products. Thus the Atka mackerel family of fish has been used for partial substitution during manufacturing of a kneaded product using a fish that has gelation strength.

Kidney tissue of a fish is the tissue attached to the bottom of the backbone, including the associated blood, and this might be removed for some purpose of the fish meat. Equipment for removal of kidney tissue is known (Patent Document 1).

[Patent Document 1] Unexamined Laid-open Patent Application No. 2006-61040

The object of the present technology is tied to the effective use of a natural resource and is to provide a frozen minced fish meat that has high quality. In particular, the object of the present technology is to provide a minced fish meat that has preferred physical properties as a raw material for a kneaded product and has frozen storability.

### SUMMARY OF THE INVENTION

While carrying out investigations for increasing gelation ability using frozen minced fish meat from various types of fish, by devising a manufacturing method for the production of minced fish meat especially from the Atka mackerel family, the inventors of the present technology accomplished the present technology by successful production of a minced fish meat having a degree of quality that was heretofore unseen.

The gist of the present technology is a method of production of a minced fish meat (items (1) through (3)) and a minced fish meat (items (4) through (7)).

(1) A method for the production of a minced fish meat without causing a lowering of gelation strength, the method including steps of: removing a head, guts, and kidney tissue (kidneys); and harvesting meat thereafter.

(2) The production method according to (1), where the method includes as essential steps:

a step of washing a fish body; a step of removing the head, guts, and kidney tissue; a washing step; and a meat harvesting step.

(3) The production method of (1) or (2), where the fish meat is that of a fish belonging to the genus Pleurogrammus or the order Gadiformes.

(4) A minced fish meat produced by the production method of any one of (1) through (3).

(5) The minced fish meat according to (4), where specific activity of protease as measured by peptide assay using phenol reagent solution is less than or equal to 0.001.

(6) The minced fish meat according to (5), where specific activity of protease as measured by peptide assay using phenol reagent solution is less than or equal to 0.0005.

(7) A frozen product of the minced fish meat of any of (4) through (6).

The minced fish meat produced according to the production method of the present technology is capable of use in the same manner as frozen surimi, since the minced fish meat of the production method of the present technology has frozen storability, has gelation ability, and has physical properties suitable for the raw material of a kneaded product.

### BRIEF DESCRIPTION OF THE DRAWING

FIG. 1 is a chart showing protease activity of various types of samples produced during Example 1.

### DETAILED DESCRIPTION OF THE INVENTION

Any fish meat used as raw material for surimi can be used as the fish meat raw material of the present technology. Such fish meats are exemplified by those of Alaska pollack, Pacific whiting, Atka mackerel, sardine, horse mackerel, southern blue whiting, northern blue whiting, Atlantic cutlass fish, lizardfish, white croaker, golden threadfin bream, splendid alfonsino, or the like.

In a preferred aspect of the present technology, the Atka mackerel family exemplifies fish meat used as raw material for the minced fish meat. The term “Atka mackerel family” here refers to a fishes having the scientific name Pleurogrammus azonus or the like and those belonging to the Atka mackerel sub-family of the family Hexagrammidae of the order Scorpaeniformes. Fish of the Atka mackerel family are fished in large numbers in the sea near Hokkaido. The Atka mackerel family also includes the striped Atka mackerel (Pleurogrammus monopterygius). Moreover, the present technology is also suitable for fishes belonging to the order Gadiformes. Fish belonging to the order Gadiformes are exemplified by Alaska pollack, Atlantic cod, Pacific cod, or the like.

When surimi or minced fish meat is produced from boned fish meat, the head and guts are removed from the raw material fish. At this time, the kidneys (referred to as the “kidney tissue”) remain attached to the fish beneath the backbone, even after removal of the guts. Since considerable effort is required in order to remove the kidney tissue, fish meat is harvested while leaving the kidney tissue attached.

According to the present technology, this kidney tissue was found to have strong protease activity, and it was found that high gelation ability could be obtained by producing a minced fish meat while removing this kidney tissue. Atka mackerel family minced fish meat produced by removing this kidney tissue had high frozen storability, high gelation ability, and was capable of having a whiter finished tint.

In the case of the harvesting of the fish meat from the backbone performed after removal of the fillets, the harvesting of the fish meat is performed similarly after removal of the kidney tissue.

During investigations of various types of fish meat, the inventors of the present technology discovered high protease activity in the kidneys of fish. Although proteases had been previously thought to be included as digestive enzymes in the digestive organs such as the stomach and intestines or the like, such high protease activity in the kidneys was previously unknown. This protease activity of the kidneys has a high level and was first recognized by the inventors of the present technology as a factor in the lowering quality of minced meat.

Within the present specification document, protease activity is measured by a peptide assay method using a phenol test solution. Relative to 1 part of minced fish meat, 4 parts of a buffer (0.1 M NaCl, 20 mM Tris-HCl, pH=7.5) is added, and the mixture is homogenized. After homogenization, the mixture is reacted for 1 hour at 60° C. and then treated using trichloroacetate (TCA). The amount of peptide in the TCA-soluble fraction (decomposed protein) is quantitatively measured by colorimetry using phenol test reagent, and the utilized value is calculated as specific activity per unit of protein concentration.

As indicated in the examples, the protease specific activity of surimi or minced fish meat from which just the head and guts had been removed (kidney tissue had not been removed) was about 0.0015 to 0.002. On the other hand, specific activity of a surimi using filets as raw material was less than 0.001. By carefully removing the kidney tissue, it was possible to obtain a protease specific activity that was nearly zero, i.e. less than or equal to 0.0005.

Gel strength is used as an indicator of the gel forming ability of a surimi, that is, as an indicator of the elasticity of a kneaded product. In general, this is represented by the product of the breaking strength (W value (g)) and the distance until breaking (L value (cm)) of a kneaded product (W value×L value). This J.S. (Jelly Strength) is used as an indicator of gel strength in the present technology.

The method of production of minced fish meat of the present technology will be explained using Atka mackerel family fish as an example.

Atka mackerel family fish obtained by fishing were washed. Since fishes of the Atka mackerel family are bottom fish who live in sandy regions, fine sand is attached to the mucus of the body surface, and thus such sand becomes intermixed with the minced fish meat if the fish isn't thoroughly washed. Thereafter, the head and guts are removed. At this time, in addition to removing the guts, the kidneys (kidney tissue) are removed. The kidney tissue may be removed using a machine or may be removed manually. Part of the attached kidney tissue may be removed with each bone, or just the kidney tissue itself may be removed. Thereafter, a washing step is performed to remove contamination such as blood or the like. The washing step may be performed using flowing water or may be performed by soaking in ice water or the like. After washing, excess water is removed from the fish body. Then the fish body is fed to a separator, and minced fish meat is recovered as minced fish meat. After removal of skin, sinews, and bones using a strainer, the strained fish meat is mixed with a freezing denaturation prevention agent such as sugar, sugar alcohol, and/or a polyphosphate or the like, and the mixture is frozen to become frozen minced fish meat.

The minced fish meat of the present technology can be used as a raw material for fish meat kneaded products mainly including fish meat, such as steamed minced-fish cake (kamaboko), tubular fish sausage (chikuwa), deep fried fish cake (satsumaage), imitation crab, fish sausage, or the like. Fish meat kneaded products are produced by adding secondary raw materials such as starch, gluten, common salt, sugars, sugar alcohols, seasonings, spices, and food colorings to fish meat. Kneaded products are produced by addition of secondary raw materials to surimi or minced fish meat and then processing by chopping-milling, seasoning, molding, heating, cooling, or the like. “Setting processing” is normally carried out after molding and at a temperature of 15 to 50° C., preferably 20 to 40° C., for a time period of 10 minutes to 20 hours. This setting processing process is used to increase elasticity of the fish meat. During the production of the kneaded fish meat product, the minced fish meat of the present technology can be used as a substitute for the conventional surimi. Since the water leaching step of conventional surimi production is not used, this production method is characterized in that there are more flavor components or the like.

Working examples of the present technology will now be explained below, but the present technology is in no way limited to these working examples.

### Example 1

### Production of Minced Fish Meat Using Atka Mackerel as Raw Material

Atka mackerel raw material was subjected to three types of processing to obtain minced fish meat: only removal of the head; removal of the head and guts; or removal of the head, guts, and kidney tissue. The complete body of an Atka mackerel family fish was washed, and a kitchen knife was used to (1) produce fish having only the head removed, (2) produce fish having the head and guts removed, or (3) produce fish having the head, guts, and kidney tissue removed. Next, the respective fish meat sample was washed and fed to a separator to recover fish meat in the minced form. The obtained minced fish meat was processed using a strainer to remove skin, sinews, and bones from the minced fish meat (minced fish meat). Thereafter, a freezing denaturation prevention agent was added (e.g. sugar, sugar alcohol, and/or polyphosphate, or the like), and the mixture was mixed and frozen to obtain frozen minced fish meat.

These three types of minced fish meat and a separately produced Atka mackerel surimi were measured for gelation strength, protease activity, color, and heme content.

Gelation strength measurement was performed after adding 3 percent by weight of table salt to the minced fish meat or surimi, thereby salting the sample and producing a kneaded meat. This kneaded meat was packed into a polyvinylidene chloride tube, heated, and then cooled to produce steamed minced-fish cake. A food checker apparatus with plunger of 5 mm diameter was used for physical property measurement of these steamed minced-fish cakes. The gelation strength (JS=W value×L value) was calculated as an indicator of breaking strength (W value, g) and the breakage length (L value, cm).

Item C products were heated for 40 minutes at 90° C. Item S products were heated for 60 minutes at 30° C., followed by 40 minutes at 90° C. Item M products were heated for 30 minutes at 60° C., followed by 40 minutes at 90° C. Item S is a test system that strongly reflects “setting processing”. Item M is a test system reflecting “returning processing”.

The results are shown in Table 1. Atka mackerel surimi was used as the reference product. Products that also had the kidney tissue removed were found to have increased gelation strength for each of the item C products, item S products, and item M products; and results were obtained that were higher than for surimi. Non-formation of gel made some of the item M product measurements impossible.

TABLE 1

| | | Item C product | | | Item S product | | | Item M product | | |
|---|---|---|---|---|---|---|---|---|---|---|
| | | W | L | JS | W | L | JS | W | L | JS |
| minced | head removal | 145 | 0.78 | 113 | 127 | 0.70 | 89 | not able to measure | | |
| fish | head and gut | 197 | 0.90 | 176 | 180 | 0.83 | 149 | not able to measure | | |
| meat | removal | | | | | | | | | |
| | head, gut, and | 217 | 0.96 | 208 | 201 | 0.86 | 172 | 176 | 0.81 | 143 |
| | kidney tissue | | | | | | | | | |
| | removal | | | | | | | | | |

| | | | | | | | |
|---|---|---|---|---|---|---|---|
| surimi | 209 | 0.87 | 181 | 169 | 0.65 | 109 | not able to measure |

Protease activity was measured by adding to the minced fish meat or surimi a 4-fold amount of a buffer (0.1 M NaCl, 20 mM Tris-HCl, pH 7.5). After homogenization, the mixture was reacted for 1 hour at 60° C., followed by TCA treatment. The peptide amount (protein decomposition product) in the TCA soluble fraction was measured quantitatively by colorimetry using phenol test reagent, and specific activity was calculated per unit of protein concentration.

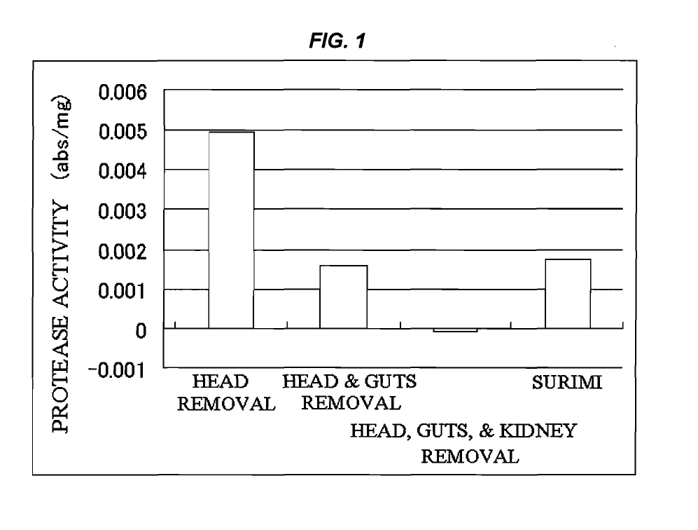

The results are shown in FIG. 1. Although the protease activity was high for the minced fish meat produced after simply removing the head, the protease activity of the minced fish meat produced after removal of the head and guts was similar to that of surimi. Protease activity of produced minced fish meat after further removal of the kidney tissue was nearly zero. Protease activity declined due to removal of the guts and kidney tissue, and this decline of protease activity is thought to contribute to improvement of gelation strength.

The steamed minced-fish cake produced for gelation strength testing was cut into 25 mm thick, and color (L*, a*, and b* values) of the sliced face was measured by a color-difference meter. Measurements were performed 10 times for each test group, and the average values were used. As L* value increases, the sample becomes more white. As a* value increases, the sample becomes more red tinted. As b* value increases, the sample becomes more yellow tinted.

Heme content (indication of the degree of intermixing of blood) was measured by the below listed method. Relative to 1 part of minced fish meat, 10 parts of acetone (containing 1% hydrochloric acid) was added. The mixture was mixed and filtered to produce an extract solution. To the obtained extract solution was added a chloroform-methanol solution, and the mixture was shaken and allowed to sit. Then the chloroform layer was recovered. Light absorption (385 nm) of the recovered solution was determined as a measure of the heme content. Absorption increases as the heme content increases.

Results are shown in Table 2. The minced fish meat produced after removal of the guts and kidney tissue was somewhat red and yellow tinted in comparison to surimi, however, it was whiter than the minced fish meat produced after removal of just the head and guts. Moreover, the amount of intermixed blood, as indicated by the heme content, greatly decreased.

TABLE 2

| | | | | | Heme content |
|---|---|---|---|---|---|
| | | | | | (365 nm |
| | | L* | a* | b* | absorption) |
| minced | head removal | 64.68 | 3.32 | 14.80 | 0.993 |
| fish meat | head and gut removal | 66.60 | 1.60 | 13.98 | 0.691 |
| | head, gut, and kidney | 68.57 | 0.58 | 12.85 | 0.499 |
| | tissue removal | | | | |
| surimi | | 74.78 | −1.32 | 6.79 | 0.127 |

By use of the method of the present technology, a frozen minced fish meat can be produced that has high general versatility and is capable of being used in a manner similar to surimi. In particular Atka mackerel family minced fish meat has excellent frozen storage ability, gel formation ability, and color. Furthermore, this minced fish meat contains a large amount of water soluble protein and is able to be used as a raw material or various types of kneaded products or the like.

While the present invention has been described in detail and with reference to specific embodiments thereof, it will be apparent to one skilled in the art that various changes and modifications can be made therein without departing from the scope thereof.

This application is based on Japanese patent application No. 2010-203883 filed on Sep. 13, 2010, the entire contents thereof being hereby incorporated by reference.

What is claimed is:

1. A method for the production of a minced fish meat without causing a lowering of gelation strength; the method comprising steps of:
removing a head, guts, and kidney tissue (kidneys); and
harvesting meat thereafter.

2. The production method according to claim 1, wherein the method includes as essential steps:
a step of washing a fish body;
a step of removing the head, guts, and kidney tissue;
a washing step;
and a meat harvesting step.

3. The production method according to claim 1, wherein the fish meat is that of a fish belonging to the genus Pleurogrammus or the order Gadiformes.

4. A minced fish meat produced by the production method according to claim 1.

5. The minced fish meat according to claim 4, wherein specific activity of protease as measured by peptide assay using phenol reagent solution is less than or equal to 0.001.

6. The minced fish meat according to claim 5, wherein specific activity of protease as measured by peptide assay using phenol reagent solution is less than or equal to 0.0005.

7. A frozen product of the minced fish meat according to claim 4.
